(19) United States
(12) Patent Application Publication
(10) Pub. No.: US 2025/0035462 A1
(43) Pub. Date: Jan. 30, 2025

(54) SYSTEM AND METHOD FOR TRACKING OBJECTS RELATIVE TO A VEHICLE

(71) Applicant: GM GLOBAL TECHNOLOGY OPERATIONS LLC, Detroit, MI (US)

(72) Inventors: Benjamin Tran, Royal Oak, MI (US); Matthew E. Gilbert-Eyres, Rochester Hills, MI (US); James Doherty, Canton, MI (US); Kevin W. Owens, Sterling Heights, MI (US)

(73) Assignee: GM GLOBAL TECHNOLOGY OPERATIONS LLC, Detroit, MI (US)

(21) Appl. No.: 18/358,391

(22) Filed: Jul. 25, 2023

(51) Int. Cl. G01C 21/36

(52) U.S. Cl. CPC G01C 21/3697

(57) ABSTRACT

A method of tracking objects relative to a vehicle. The method includes identifying a route object list associated with a predetermined vehicle route. The route object list includes a list of objects to be taken on the vehicle for the predetermined vehicle route. At least one object associated with the vehicle with at least one sensor on the vehicle is identified to determine a current object list for the vehicle. The current object list is compared to the route object list associated with the predetermined route to identify at least one missing object from the current object list when compared to the route object list. A notification is provided to a user of the at least one missing object.

### INTRODUCTION

The present disclosure relates to a system and a method for tracking objects relative to a vehicle.

When traveling in a vehicle, the occupants usually have a number of objects they wish to bring with them. For example, when traveling to the gym the occupants may have a gym bag or when taking children to school, each child might have a backpack. However, it can be easy to forget or leave behind particular objects needed for a trip. Therefore, there is a need to improve object management when traveling in a vehicle.

### SUMMARY

Disclosed herein is a method of tracking objects relative to a vehicle. The method includes identifying a route object list associated with a predetermined vehicle route. The route object list includes a list of objects to be taken on the vehicle for the predetermined vehicle route. At least one object associated with the vehicle with at least one sensor on the vehicle is identified to determine a current object list for the vehicle. The current object list is compared to the route object list associated with the predetermined route to identify at least one missing object from the current object list when compared to the route object list. A notification is provided to a user of the at least one missing object.

Another aspect of the disclosure may be where the route object list includes a list of objects identified with the vehicle from an immediately prior route traveled by the vehicle.

Another aspect of the disclosure may include determining a future route for the vehicle.

Another aspect of the disclosure may be where determining the future route for the vehicle includes predicting a destination based on utilizing a trip history for the vehicle.

Another aspect of the disclosure may be where determining the future route for the vehicle includes receiving the route from a navigation system associated with the vehicle.

Another aspect of the disclosure may be where determining the future route for the vehicle includes identifying a newly traveled route by monitoring a vehicle path from an origin location to a destination location.

Another aspect of the disclosure may include associating the current object list with the newly traveled route.

Another aspect of the disclosure may include identifying a user response to the notification and assigning a level of importance to the at least one missing object based on the user response.

Another aspect of the disclosure may be where the at least one missing object is maintained in the route object list if the user responds to the notification.

Another aspect of the disclosure may be where the at least one missing object is removed from the route object list if the user fails to respond to the notification.

Another aspect of the disclosure may be where the current object includes at least one discoverable connected device.

Another aspect of the disclosure may be where the at least one sensor includes an RFID reader and the at least one object associated with the vehicle includes an RFID tag.

Another aspect of the disclosure may be where the at least one sensor includes at least one camera and identifying the at least one object associated with the vehicle includes capturing a plurality of images of an area surrounding the vehicle with the at least one camera and performing image recognition on the plurality of images.

Another aspect of the disclosure may be where performing object detection includes performing facial recognition and associating at least one predetermined object with the route object list based on the facial recognition.

Another aspect of the disclosure may be where comparing the current object list with the route object list includes identifying at least one additional object in the current object list when compared to the route object list.

Disclosed herein is a non-transitory computer-readable medium embodying programmed instructions which, when executed by a processor, are operable for performing a method. The method includes identifying a route object list associated with a predetermined vehicle route. The route object list includes a list of objects to be taken on the vehicle for the predetermined vehicle route. At least one object associated with the vehicle with at least one sensor on the vehicle is identified to determine a current object list for the vehicle. The current object list is compared to the route object list associated with the predetermined route to identify at least one missing object from the current object list when compared to the route object list. A notification is provided to a user of the at least one missing object.

Disclosed herein is a vehicular system. The system includes a plurality of sensors and a controller in communication with the plurality of sensors. The controller is configured to identify a route object list associated with a predetermined vehicle route. The route object list includes a list of objects to be taken on a vehicle for the predetermined vehicle route. At least one object associated with the vehicle when at least one sensor on the vehicle is identified to determine a current object list for the vehicle. The current object list is compared to the route object list associated with the predetermined route to identify at least one missing object from the current object list when compared to the route object list. A notification is provided to a user of the at least one missing object.

### BRIEF DESCRIPTION OF THE DRAWINGS

FIG. 1 is a schematic illustration of an example autonomous motor vehicle.

FIG. 2 illustrates an example method of tracking objects relative to a vehicle.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

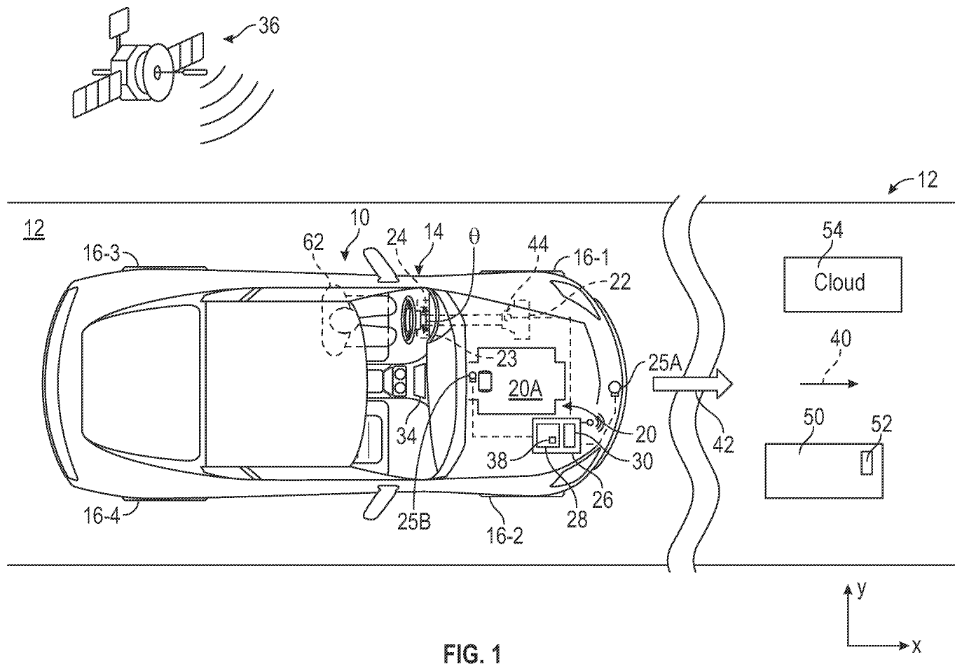

Referring to the FIGS., wherein like numerals indicate like parts referring to the drawings, wherein like reference numbers refer to like components, FIG. 1 shows a schematic view of a motor vehicle 10 positioned relative to a road surface, such as a vehicle lane 12. As shown in FIG. 1, the vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide fictional contact with the vehicle lane 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the vehicle lane 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators 22 (for example, an electrical power steering unit) configured to steer the road wheels 16-1, 16-2, a steering angle (0), an accelerator device 23 for controlling power output of the power-source(s) 20A, a braking switch or device 24 for retarding rotation of the road wheels 16-1 and 16-2 (such as via individual friction brakes located at respective road wheels), etc.

As shown in FIG. 1, the motor vehicle 10 includes at least one sensor 25A and an electronic controller 26 that cooperate to at least partially control, guide, and maneuver the vehicle 10 in an autonomous mode during certain situations. As such, the vehicle 10 may be referred to as an autonomous vehicle. To enable efficient and reliable autonomous vehicle control, the electronic controller 26 may be in operative communication with the steering actuator(s) 22 configured as an electrical power steering unit, accelerator device 23, and braking device 24. The sensors 25A of the motor vehicle 10 are operable to sense the vehicle lane 12 and monitor a surrounding geographical area and traffic conditions proximate the motor vehicle 10.

The sensors 25A of the vehicle 10 may include, but are not limited to, at least one of a Light Detection and Ranging (LIDAR) sensor, radar, and camera located around the vehicle 10 to detect the boundary indicators, such as edge conditions, of the vehicle lane 12. The sensors 25A can also be located within a passenger compartment of the vehicle 10 in order to have a view of the occupants and cargo area within the vehicle 10. The type of sensors 25A, their location on the vehicle 10, and their operation for detecting and/or sensing the boundary indicators of the vehicle lane 12 and monitor the surrounding geographical area and traffic conditions are understood by those skilled in the art and are therefore not described in detail herein. The vehicle 10 may additionally include sensors 25B, such as RFID readers, attached to the vehicle body. The sensors 25B can be positioned adjacent entry points into the vehicle 10 to determine if an object having an RFID tag enters the vehicle.

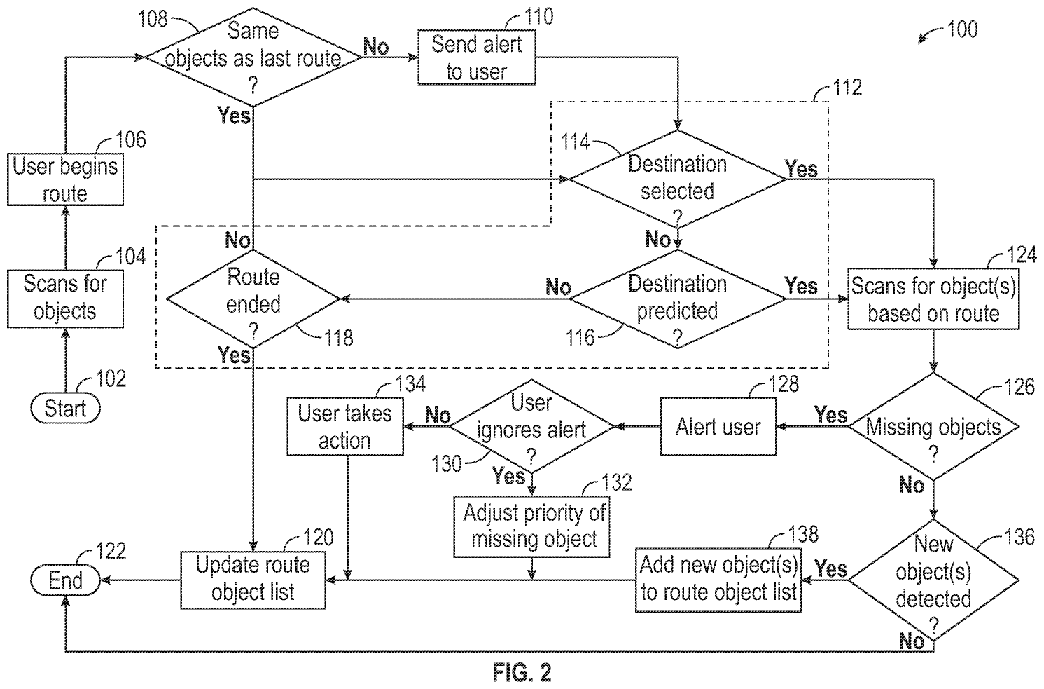

The electronic controller 26 is disposed in communication with the sensors 25A of the vehicle 10 for receiving their respective sensed data related to the detection or sensing of the vehicle lane 12 and monitoring of the surrounding geographical area and traffic conditions. The electronic controller 26 may alternatively be referred to as a control module, a control unit, a controller, a vehicle 10 controller, a computer, etc. The electronic controller 26 may include a computer and/or processor 28, and include software, hardware, memory, algorithms, connections (such as to sensors 25A and 25B), etc., for managing and controlling the operation of the vehicle 10. As such, a method, described below and generally represented in FIG. 2, may be embodied as a program or algorithm partially operable on the electronic controller 26. It should be appreciated that the electronic controller 26 may include a device capable of analyzing data from the sensors 25A and 25B, comparing data, making the decisions required to control the operation of the vehicle 10, and executing the required tasks to control the operation of the vehicle 10.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 26 includes a tangible, non-transitory memory 30 on which computer-executable instructions, including one or more algorithms, are recorded for regulating operation of the motor vehicle 10. The subject algorithm(s) may specifically include an algorithm configured to monitor localization of the motor vehicle 10 and determine the vehicle's heading relative to a mapped vehicle trajectory on a particular road course to be described in detail below.

The motor vehicle 10 also includes a vehicle navigation system 34, which may be part of integrated vehicle controls, or an add-on apparatus used to find travel direction in the vehicle. The vehicle navigation system 34 is also operatively connected to a global positioning system (GPS) 36 using an earth orbiting satellite. The vehicle navigation system 34 in connection with the GPS 36 and the above-mentioned sensors 25A may be used for automation of the vehicle 10. The electronic controller 26 is in communication with the GPS 36 via the vehicle navigation system 34. The vehicle navigation system 34 uses a satellite navigation device (not shown) to receive its position data from the GPS 36, which is then correlated to the vehicle's position relative to the surrounding geographical area. Based on such information, when directions to a specific waypoint are needed, routing to such a destination may be mapped and calculated. On-the-fly terrain and/or traffic information may be used to adjust the route. The current position of a vehicle 10 may be calculated via dead reckoning—by using a previously determined position and advancing that position based upon given or estimated speeds over elapsed time and course by way of discrete control points.

The electronic controller 26 is generally configured, i.e., programmed, to determine or identify localization 38 (current position in the X-Y plane, shown in FIG. 1), velocity, acceleration, yaw rate, as well as intended path 40, and heading 42 of the motor vehicle 10 on the vehicle lane 12. The localization 38, intended path 40, and heading 42 of the motor vehicle 10 may be determined via the navigation system 34 receiving data from the GPS 36, while velocity, acceleration (including longitudinal and lateral g's), and yaw rate may be determined from vehicle sensors 25B. Alternatively, the electronic controller 26 may use other systems or detection sources arranged remotely with respect to the vehicle 10, for example a camera, to determine localization 38 of the vehicle relative to the vehicle lane 12.

As noted above, the motor vehicle 10 may be configured to operate in an autonomous mode guided by the electronic controller 26 to transport an occupant 62. In such a mode, the electronic controller 26 may further obtain data from vehicle sensors 25B to guide the vehicle along the desired path, such as via regulating the steering actuator 22. The electronic controller 26 may be additionally programmed to detect and monitor the steering angle (0) of the steering actuator(s) 22 along the desired path 40, such as during a negotiated turn. Specifically, the electronic controller 26 may be programmed to determine the steering angle (0) via receiving and processing data signals from a steering position sensor 44 (shown in FIG. 1) in communication with the steering actuator(s) 22, accelerator device 23, and braking device 24.

FIG. 2 illustrates a method 100 for tracking objects relative to the vehicle 10. The method 100 can track a number of different types of objects, such as people, bags, or equipment, as will be explained in greater detail below. One feature of the method 100 is to develop packing lists, such as route object lists for bringing on the vehicle 10 for a predetermined vehicle route. The route can be determined based on a predetermined origin location associated with a corresponding destination location, a destination location independent of the origin location, or an origin location independent of the destination location. The route object lists can also be shared among different vehicles in the same household, with a single account, a vehicle fleet, or a discoverable device through the electronic controller 26 communicating through cloud 54 to access stored data regarding the route object lists.

The method 100 begins at Block 102 and then scans for objects at Block 104. In the illustrated example, the method 100 begins scanning for objects prior to the driver starting a route at Block 106. This allows the method 100 to identify objects as they approach the vehicle 10, such as a person with a proximity key.

The method 100 scans for objects in a number of different ways. In one example, the method 100 at Block 104 can identify discoverable devices that form a Bluetooth, Wi-Fi, or other types of wireless connections with the vehicle 10. The discoverable devices can include mobile devices, wearables, tablets, or proximity keys associated with the vehicle 10. The wearable devices are also helpful in identifying a particular user or users in the vehicle 10 when a particular wearable is associated with a given user.

In another example, the method 100 at Block 104 utilizes the sensors 25B, such as the RFID tag reader, to identify RFID tags 52 associated with objects 50 (FIG. 1). The RFID tags 52 can be associated with specific objects 50 such the method 100 can determine which objects 50 are being brought along with the vehicle 10 by reading the RFID tags 52. Alternatively, a specific set of RFID tags 52 can be used with a group of predetermined objects associated with a predetermined route for the vehicle 10.

In another example, the method 100 at Block 104 utilizes at least one camera from the sensors 25A to perform image recognition on images captured from an area surrounding the vehicle 10. The area surrounding the vehicle 10 can include at least one of an area within a predetermined distance of the vehicle 10, within a passenger compartment of the vehicle 10, or within a cargo compartment of the vehicle 10. The image recognition performed at Block 104 can include facial recognition for identifying specific people or object detection for identifying specific objects. Additionally, the facial recognition can include associating at least one predetermined object with the route object list based on the facial recognition.

The method 100 can then compare the plurality of currently recognized objects with a plurality of previously recognized objects from a route traveled immediately previously with the vehicle 10 at Block 108. If the plurality of currently recognized objects fails to match the plurality of previously recognized objects, an alert or notification (Block 110) is sent to the driver of the vehicle 10 that at least one object might be left behind. If the plurality of currently recognized objects matches the plurality of previously recognized objects, the method proceeds to Block 112 to determine a route for the vehicle 10.

The method 100 can determine the route for the vehicle 10 at Block 112 in a number of different ways. In one example, the route for the vehicle 10 is determined based on the destination being input into the navigation system 34 on the vehicle 10 with the navigation system 34 being able to provide the current location of the vehicle 10 for determining the origin of the route. The method 100 can also receive the destination independently of the navigation system 34, such as from a user's mobile device.

In another example, the route for the vehicle 10 is determined through predicting the destination based on utilizing a trip history database for the vehicle 10 in connection with a current location of the vehicle 10. For example, the trip history database can be maintained with the controller 26 and include dates, travel times, and origin locations with associated destination locations for each trip.

If the route is not provided (Block 114) and the route cannot be predicted (Block 116), the vehicle 10 will record the origin for when the current route began and the destination when the route ends (Block 118) to establish a new route for the vehicle 10 that can be stored in the trip history database. The plurality of currently recognized objects will be associated with the new route at Block 120 before the method 100 ends at Block 122.

If the destination is selected in the navigation system 34 (Block 114) or the route is predicted (Block 116), the method 100 can then perform an additional scan for objects (Block 124) associated with the vehicle 10 or rely on the scan for objects performed at Block 104 to determine the current object list for the vehicle 10. The method 100 can then compare the current object list with the route object list associated with the route at Block 124.

The method 100 can then determine if the current object list includes at least one missing object when compared to the route object list (Block 126). If the method determines that there is at least one missing object, the method 100 can alert the driver to the missing object (Block 128) and give the driver the opportunity to take an action (Block 130) in response to the alert, such as to obtain the missing object.

If the driver decides to ignore the alert, the method 100 can adjust the weight or priority of the at least one missing object (Block 132). The weight or priority corresponds to a level of importance placed on the at least one missing object by one of the users of the vehicle 10. The change in weight or priority for the at least one missing object in the current object list is updated at Block 120 to become associated with the route object list for the given route. If the at least one missing object is left behind on a repeated basis for a given route and the driver continues to ignore the alert regarding the at least one missing object, the method 100 may update the route object list associated with the route to remove the at least one object that is repeated missed (Block 120). If the driver decides to take action (Block 134) in response to the alert from Block 128, the method 100 will maintain the missing object associated with the plurality of predetermined objects associated with the given route.

Furthermore, if the method 100 fails to identify at least one missing objects at Block 126, the method 100 will then determine if there are additional objects identified in the current object list that were not in the route object list for the given route (Block 136). If it is determined that there are no additional objects in the current object list when compared to the route object list, the method 100 proceeds to Block 122 and ends. If the current object list includes objects that do not appear in the route object list (Block 138), the method 100 can update the route object list with the new objects at Block 120 before ending at Block 122.

While various embodiments have been described, the description is intended to be exemplary rather than limiting. It will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What we claim is:

1. A method of tracking objects relative to a vehicle, the method comprising:
identifying a route object list associated with a predetermined vehicle route, wherein the route object list includes a list of objects to be taken on the vehicle for the predetermined vehicle route;
identifying at least one object associated with the vehicle with at least one sensor on the vehicle to determine a current object list for the vehicle;
comparing the current object list to the route object list associated with the predetermined route to identify at least one missing object from the current object list when compared to the route object list; and
providing a notification to a user of the at least one missing object.

2. The method of claim 1, wherein the route object list includes a list of objects identified with the vehicle from an immediately prior route traveled by the vehicle.

3. The method of claim 1, including determining a future route for the vehicle.

4. The method of claim 3, wherein determining the future route for the vehicle includes predicting a destination based on utilizing a trip history for the vehicle.

5. The method of claim 3, wherein determining the future route for the vehicle includes receiving the route from a navigation system associated with the vehicle.

6. The method of claim 3, wherein determining the future route for the vehicle includes identifying a newly traveled route by monitoring a vehicle path from an origin location to a destination location.

7. The method of claim 6, including associating the current object list with the newly traveled route.

8. The method of claim 1, including identifying a user response to the notification and assigning a level of importance to the at least one missing object based on the user response.

9. The method of claim 8, wherein the at least one missing object is maintained in the route object list if the user responds to the notification.

10. The method of claim 8, wherein the at least one missing object is removed from the route object list if the user fails to respond to the notification.

11. The method of claim 1, wherein the current object includes at least one discoverable connected device.

12. The method of claim 1, wherein the at least one sensor includes an RFID reader and the at least one object associated with the vehicle includes an RFID tag.

13. The method of claim 1, wherein the at least one sensor includes at least one camera and identifying the at least one object associated with the vehicle includes capturing a plurality of images of an area surrounding the vehicle with the at least one camera and performing image recognition on the plurality of images.

14. The method of claim 13, wherein performing object detection includes performing facial recognition and associating at least one predetermined object with the route object list based on the facial recognition.

15. The method of claim 1, wherein comparing the current object list with route object list includes identifying at least one additional object in the current object list when compared to the route object list.

16. A non-transitory computer-readable medium embodying programmed instructions which, when executed by a processor, are operable for performing a method comprising:
identifying a route object list associated with a predetermined vehicle route, wherein the route object list includes a list of objects to be taken on a vehicle for the predetermined vehicle route;
identifying at least one object associated with the vehicle with at least one sensor on the vehicle to determine a current object list for the vehicle;
comparing the current object list to the route object list associated with the predetermined vehicle route to identify at least one missing object from the current object list when compared to the route object list; and
providing a notification to a user of the at least one missing object.

17. The computer-readable medium of claim 16, wherein the route object list includes a list of objects identified with the vehicle from an immediately prior route traveled by the vehicle.

18. The computer-readable medium of claim 16, including identifying a user response to the notification and assigning a level of importance to the at least one missing object based on the user response.

19. The computer-readable medium of claim 16, wherein the at least one sensor includes at least one camera and identifying the at least one object associated with the vehicle includes capturing a plurality of images of an area surrounding the vehicle with the at least one camera and performing image recognition on the plurality of images.

20. A vehicular system comprising:
a plurality of sensors; and
a controller in communication with the plurality of sensors and configured to:
identify a route object list associated with a predetermined vehicle route, wherein the route object list includes a list of objects to be taken on a vehicle for the predetermined vehicle route;
identify at least one object associated with the vehicle with at least one sensor on the vehicle to determine a current object list for the vehicle;
compare the current object list to the route object list associated with the predetermined route to identify at least one missing object from the current object list when compared to the route object list; and
provide a notification to a user of the at least one missing object.
